(19) United States
(12) Patent Application Publication
(10) Pub. No.: US 2020/0382467 A1
(43) Pub. Date: Dec. 3, 2020

(54) SYSTEM WITH PURPOSE-SPECIFIC IDENTIFIERS FOR VIRTUAL NETWORK INTERFACE CARD

(71) Applicant: Mastercard International Incorporated, Purchase, NY (US)

(72) Inventors: Chase A. Aleshire, O'Fallon, MO (US); Benjamin D. Williams, Pacifica, CA (US)

(73) Assignee: Mastercard International Incorporated, Purchase, NY (US)

(21) Appl. No.: 16/425,798

(22) Filed: May 29, 2019

(51) Int. Cl. H04L 29/12; H04L 12/931; G06F 9/455

(52) U.S. Cl. CPC H04L 61/6004; H04L 61/20; G06F 2009/45595; G06F 9/45558; H04L 49/70

(57) ABSTRACT

A system having standardized addresses for virtual network interface cards, with each card address including one or more purpose-specific identifiers to better facilitate identification and management of the virtual card. A blade or other server or other equipment includes multiple virtual machines, with each virtual machine accessing a network via a virtual card. Each virtual card is associated with a particular fabric interconnect and a particular virtual switch. Each virtual card has a media access control address having six octets, including a fourth octet which includes a server connection hexadecimal value which identifies the particular fabric and a side connection hexadecimal value which identifies the particular virtual switch to which the virtual card is connected. Each possible fabric connection and each possible switch connection may be identified by one of two or more values.

### FIELD

The present invention relates to systems and methods for managing electronic equipment, and more particularly, embodiments concern a system with standardized electronic addresses for virtual network interface cards, with each such address including one or more purpose-specific identifiers to better facilitate identification and management of the virtual network interface card.

### BACKGROUND

The Cisco Unified Computing System™ (Cisco UCS®) is a data center server computer product line which includes computing hardware, virtualization support, switching fabric, and management software. A UCS may include blade servers, which are server computers having a modular design and a reduced number of components to minimize physical space requirements and power consumption while still having all of the functional components to be considered computers. An active blade server has a service profile identifier which identifies the logical configuration applied to the physical equipment, and an equipment identifier which identifies the physical equipment itself.

Ideally, the equipment identifier matches or at least includes the service profile identifier, so that when a particular blade server is called out by its service profile identifier, a technician can quickly and easily identify the correct physical equipment by its corresponding equipment identifier. Normally, assigning equipment identifiers to blade servers in a UCS requires separately logging-in to each blade server and manually performing the labelling process, which can be time-consuming if there are a large number of blade servers or the service profile identifiers change frequently. Without proper equipment identifiers, there is an increased risk of identifying the wrong physical equipment. Further, errors can occur when manually configuring these identifiers, or non-standard identifiers may be applied, which can also increase the risk of identifying the wrong physical equipment.

The servers in a UCS may be virtualized, which may involve partitioning a single physical server into multiple virtual machines (VMs), with each VM running its own operating system and application. One advantage of VMs is that they can be moved or copied from one physical server to another to balance loads or to expand processing capability. Within virtualized servers, VMs connect to fabrics via virtual network interface cards (vNICs).

A media access control (MAC) address is a unique forty-eight (48) bit serial number for Ethernet and Wi-Fi devices. MAC addresses work with vNICs to allow servers and other electronic systems to connect to networks. MAC addresses are divided into six octets, with the first three octets forming a twenty-four (24) bit organizational unique identifier (OUI) which identifies the organization that issued the identifier, and the final three octets forming a twenty-four (24) bit number which identifies a specific vNIC. The fifth and sixth octets are typically randomly assigned. However, it is known to use part of the fourth octet to more specifically identify the equipment. For example, the values A and B have been used to represent switch sides, and the values 0 and 1 have been used to represent city locations (e.g., 0 for St. Louis, 1 for Kansas City). To replace or interchange a blade server in a UCS, the MAC address for each vNIC must be determined, and it may also be desirable to determine the type of server connection to which the vNIC is connected and to which side of the redundant fabric interconnects (or switches) the vNIC is assigned. Making such determinations, especially for a number of vNICs, can be time-consuming and introduce errors.

This background discussion is intended to provide information related to the present invention which is not necessarily prior art.

### SUMMARY

Embodiments address the above-described and other problems and limitations in the prior art by providing a system with standardized vNIC addresses, with each vNIC address including one or more purpose-specific identifiers to better facilitate identification and management of the vNICs.

In one embodiment, a system may include a server including a plurality of vNICs. Each vNIC may be associated with a particular connection of two or more possible connections and a particular side of two or more possible sides, and each vNIC may be assigned an electronic address. The electronic address may include a connection value which identifies the particular connection, and a side value which identifies the particular side. Various implementations of this embodiment may include any one or more of the following features. The server may be a blade server, and the electronic address may be a MAC address. The two or more possible connections may include a first physical fabric and a second physical fabric. The two or more possible sides may include a first virtual switch and a second virtual switch. Each possible connection of the two or more possible connections may be identified by one of two or more values. The electronic address may be a unique address within a particular network, and each possible connection of the two or more possible connections may be identified by one or more additional values to achieve the unique address. Each possible side of the two or more possible sides may be identified by one of two or more values. The electronic address may be a unique address, and each possible side of the two or more possible sides may be identified by one or more additional values to achieve the unique address.

In another embodiment, a system may include a blade server including a plurality of vNICs. Each vNIC may be associated with a particular server connection of two or more possible server connections and a particular side connection of two or more possible side connections, and each vNIC may be assigned a MAC. The MAC address may include a server connection value which identifies the particular server connection, and a side connection value which identifies the particular side connection. Various implementations of this embodiment may include any one or more of the following features. The two or more possible server connections may include a first physical fabric and a second physical fabric. The two or more possible side connections may include a first virtual switch and a second virtual switch. The MAC address may include six octets, with each octet including two hexadecimal values. The server connection value and the side connection value may be in a fourth octet of the MAC address. Each possible server connection of the two or more possible server connections may be identified by one of two or more hexadecimal values. The electronic address may be a unique address within a particular network, and each possible server connection of the two or more possible server connections may be identified by one or more additional hexadecimal values to achieve the unique address. Each possible side connection of the two or more possible connections may be identified by one of two or more hexadecimal values. The electronic address may be a unique address within a particular network, and each possible side connection of the two or more possible side connection may be identified by one or more additional hexadecimal values to achieve the unique address.

In another embodiment, a system may include a blade server including a plurality of VMs and a plurality of vNICs. Each VM may run an operating system and a software application and may be connected via a first virtual port to a first switch and may be connected via a second virtual port to a second switch. Two or more first vNICs may be connected to the first virtual switch, and one of the first vNICs may be connected to a first physical fabric and another of the first vNICs may be connected to a second physical fabric. Two or more second vNICs may be connected to the second virtual switch, and one of the second vNICs may be connected to the first physical fabric and another of the second virtual network interface cards may be connected to the second physical fabric. Each of the first and second vNICs may be assigned a media access control address having six octets, including a fourth octet which may include a connection hexadecimal value which identifies the particular first or second physical fabric to which the virtual network interface card is connected, and a side hexadecimal value which identifies the particular first or second virtual switch to which the virtual network interface card is connected.

Various implementations of this embodiment may include any one or more of the following features. The virtual network interface cards may be connected to the first and second physical fabrics by an input/output module. Each of the first and second physical fabrics may be connected to two or more uplink switches.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a diagram of an embodiment of a system for automatically and robustly standardizing electronic equipment identifiers with service profile identifiers in the one or more domains of a UCS to better facilitate identification of the physical equipment; and

FIG. 2 is a flowchart of an embodiment of a method and/or computer-implemented method for automatically and robustly standardizing electronic equipment identifiers with service profile identifiers in the one or more domains of a UCS to better facilitate identification of the physical equipment;

FIG. 3 is a flowchart of additional steps in an implementation of the method of FIG. 2;

FIG. 4 is a diagram of a virtualized server having a plurality of vNICs; and

FIG. 5 is a vNIC address scheme illustrating the assignment of vNIC addresses for at least some of the plurality of vNICs of the virtualized server of FIG. 4.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

Broadly, embodiments provide a system, method, and computer-implemented method for automatically and robustly standardizing electronic equipment identifiers with service profile identifiers within the one or more domains of a UCS to better facilitate identification of the physical equipment. The standardization process is performed automatically, thereby avoiding the time and cost disadvantages of the prior art manual process and reducing the risks of missing, incorrect, and non-standard equipment identifiers. The standardization process is also performed robustly, in that the process is repeated at regular intervals (e.g., nightly) to account for any changes to service profile identifiers and to correct any improper changes to equipment identifiers during the preceding interval, thereby further reducing the risks of missing, incorrect, and non-standard equipment identifiers.

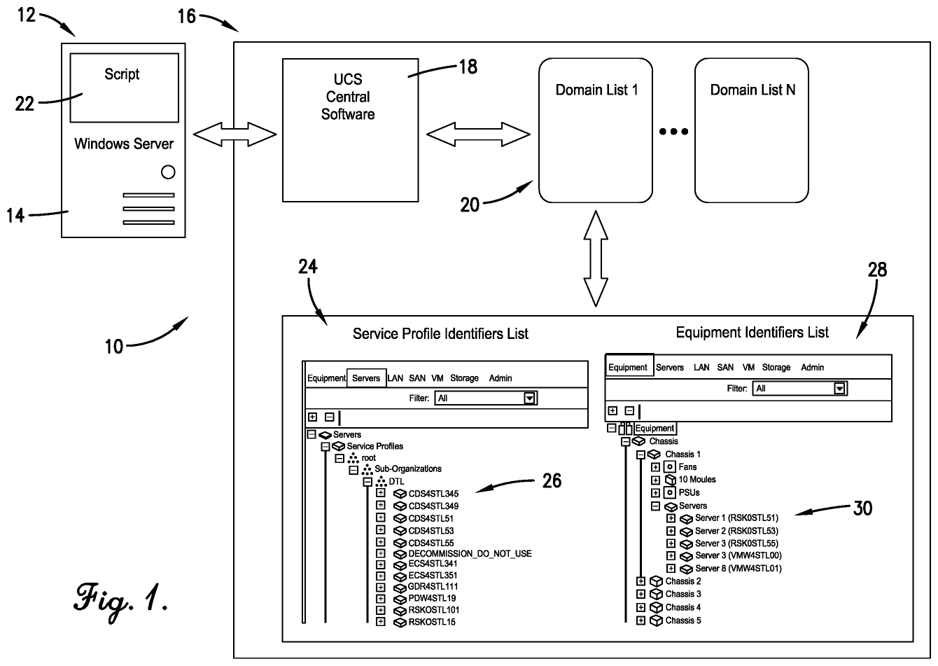

Referring to FIG. 1, an embodiment of a system 10 is shown for automatically and robustly standardizing electronic equipment identifiers with service profile identifiers in the one or more domains of a UCS to better facilitate identification of the physical equipment. The system 10 may broadly include a management network 12 including a management server 14, and a UCS 16 including a UCS central software 18 and one or more Domain Lists 20. The management network 12 including the management server 14 may be otherwise substantially conventional technologies configured to manage certain operations of the UCS 16. For example, the management server 14 may include a Windows server executing a Windows task scheduler, and the task scheduler may initiate a master script for the UCS 16. The task scheduler may also execute a script 22 implementing the standardization process.

The UCS 16 and the UCS central software 18 may be otherwise substantially conventional UCS technologies. The UCS 16 may include one or more domains, with each domain including one or more active and/or inactive blade servers or other electronic equipment. The Domain List 20 may be a list of the active domains managed by the UCS central software 18. Each domain in the Domain List 20 may be associated with a Service Profile List 24, which may be a list of all of the active Service Profile identifiers 26 for the domain. Each domain in the Domain List 20 may also be associated with an Equipment Identifier List 28, which may be a list of all of the active Equipment identifiers 30 for the domain.

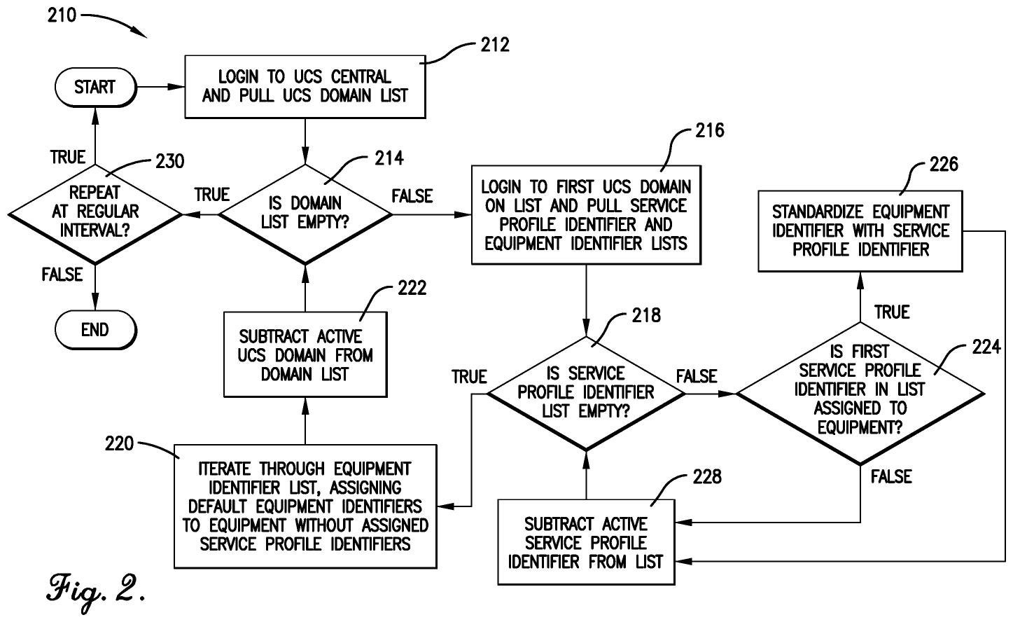

Referring also to FIG. 2, in operation the system 10 may broadly function substantially as follows. A Domain List 20 of the one or more domains of the UCS 16 may be accessed, as shown in 212, and a particular domain from the one or more domains in the Domain List 20 may be accessed, and a Service Profile Identifier List 24 of Service Profile Identifiers 26 and an Equipment Identifier List 28 of Equipment Identifiers 30 for the particular domain may be accessed, as shown in 216. If a particular Equipment Identifier 30 assigned to a particular piece of equipment (e.g., a blade server) does not include the particular Service Profile Identifier 26 assigned to that equipment, then the particular Equipment Identifier 30 may be changed to include the particular Service Profile Identifier 26, as shown in 226, to facilitate identification of the physical equipment. Each Service Profile Identifier 24 in the particular domain may be checked, as shown in 218, and the process may be repeated for any additional domains, as shown in 214. The entire process may be repeated at a regular interval (e.g., nightly), as shown in 230.

The system 10 may include more, fewer, or alternative components and/or perform more, fewer, or alternative actions, including those discussed elsewhere herein, and particularly those discussed in the following section describing the method and computer-implemented method.

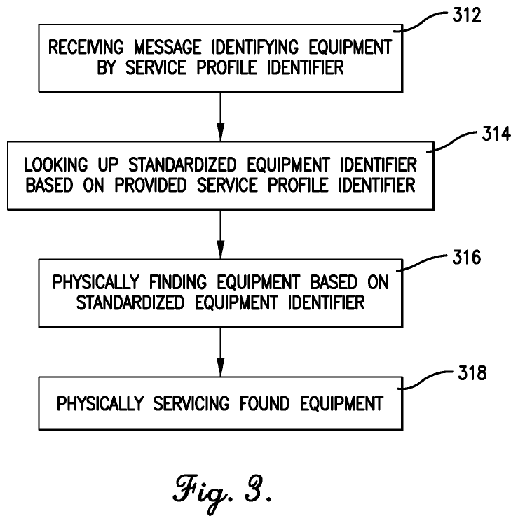

Referring to FIGS. 2 and 3, an embodiment of a method and/or computer-implemented method 210 is shown for improving the function of a UCS by automatically and robustly standardizing electronic equipment identifiers with service profile identifiers in the one or more domains of the UCS to better facilitate identification of the physical equipment. The method and/or computer-implemented method 210 may be a corollary to the functionality of the above-described system 10, and may be similarly implemented using the various components of the above-described system 10 and its exemplary operating environment. In particular, at least some of which may be performed by a computer having an electronic processor. For example, some or all of the steps of the computer-implemented method 210 may be performed by the script 22 executed by the management server 14 which is part of the management network 12 for managing certain operations of the UCS 16. Broadly, the method and/or computer-implemented method 210 may include the following steps.

A UCS central software 18 may be accessed (by, e.g., logging in), and a Domain List 20 may be accessed via the UCS central software 18, as shown in 212. The Domain List 20 may be checked to determine whether it is empty, as shown in 214. If the Domain List 20 is empty, then the method 210 may end. If the Domain List 20 is not empty, then a particular domain in the Domain List 20 may be accessed (by, e.g., logging in), and a Service Profile Identifier List 24 and an associated Equipment Identifier List 28 for the particular domain may be accessed, as shown in 216.

The Service Profile Identifier List 24 may be checked to determine whether it is empty, as shown in 218. If the Service Profile Identifier List 24 for the particular domain is empty, then any Equipment Identifiers 30 in the Equipment Identifier List 28 may be set to default Equipment Identifiers, as shown in 220, and the particular domain may be subtracted from the Domain List 20, as shown in 222, and the Domain List 20 may be checked for a next particular domain, as shown in 214.

If the Service Profile Identifier List 24 for the particular domain is not empty, then a particular Service Profile Identifier 26 in the Service Profile Identifier List 24 may be checked to determine whether it is assigned to a piece of electronic equipment, as shown in 224. If the particular Service Profile Identifier 26 in the Service Profile Identifier List 24 is not assigned to a piece of electronic equipment, then the particular Service Profile Identifier 26 may be subtracted from the Service Profile Identifier List 24, as shown in 228, and the Service Profile Identifier List 24 may be checked for the next particular Service Profile Identifier 26, as shown in 218.

If the particular Service Profile Identifier 26 in the Service Profile Identifier List 24 is assigned to a piece of electronic equipment, then the Equipment Identifier 30 of that piece of electronic equipment may be set, in part or in whole, to the Service Profile Identifier 26, as shown in 226. More specifically, if a particular Equipment Identifier 30 assigned to a particular piece of equipment (e.g., a blade server) does not include the particular Service Profile Identifier 26 assigned to that equipment, then the particular Equipment Identifier 30 may be changed to include the particular Service Profile Identifier 26, as shown in 226, to facilitate identification of the physical equipment. In one implementation, this may be accomplished by simply overwriting the Equipment Identifier 30 with the standardized label without first checking whether the Equipment Identifier 30 is already standardized. In another implementation, this may be accomplished by first checking whether the Equipment Identifier 30 is already standardized, and overwriting it only if it is not already standardized. The relevant effect of these two implementations may be the same: Standardizing any unstandardized Equipment Identifiers 30 so that all Equipment Identifiers 30 with a corresponding Service Profile Identifier 26 are standardized. Thereafter, the particular Service Profile Identifier 26 may be subtracted from the Service Profile Identifier List 24, as shown in 228, and the Service Profile Identifier List 24 may be checked for the next particular Service Profile Identifier 26, as shown in 218.

The method and/or computer-implemented method 210 may be repeated at a regular interval (e.g., nightly) to ensure that the Equipment Identifier 30 for each piece of electronic equipment continues to correctly reflect the Service Profile Identifier 26 of that piece of electronic equipment, as shown in 230.

Once the Equipment Identifiers 30 have been standardized to better facilitate identification of the physical equipment, a message (e.g., a service request) may be received identifying a particular piece of equipment by its particular Server Profile Identifier 26, as shown in 312. The particular Equipment Identifier 30 may be looked-up based on the provided particular Service Profile Identifier 26, as shown in 314. The particular piece of equipment may then be quickly and easily physically found based on the particular Equipment Identifier 30, as shown in 316, and the correct particular piece of equipment may be physically serviced, as shown in 318.

The method and/or computer-implemented method 210 may include more, fewer, or alternative actions, including those discussed elsewhere herein.

Additionally or alternatively, embodiments may provide a system with standardized port addresses, with each port address including one or more purpose-specific identifiers to better facilitate identification and management of the ports. In one implementation, the system may have standardized MAC or other electronic addresses for vNICs or other virtual network connection equipment in blade or other servers to better facilitate identifying and servicing, replacing, or otherwise managing the servers or other physical or virtual equipment.

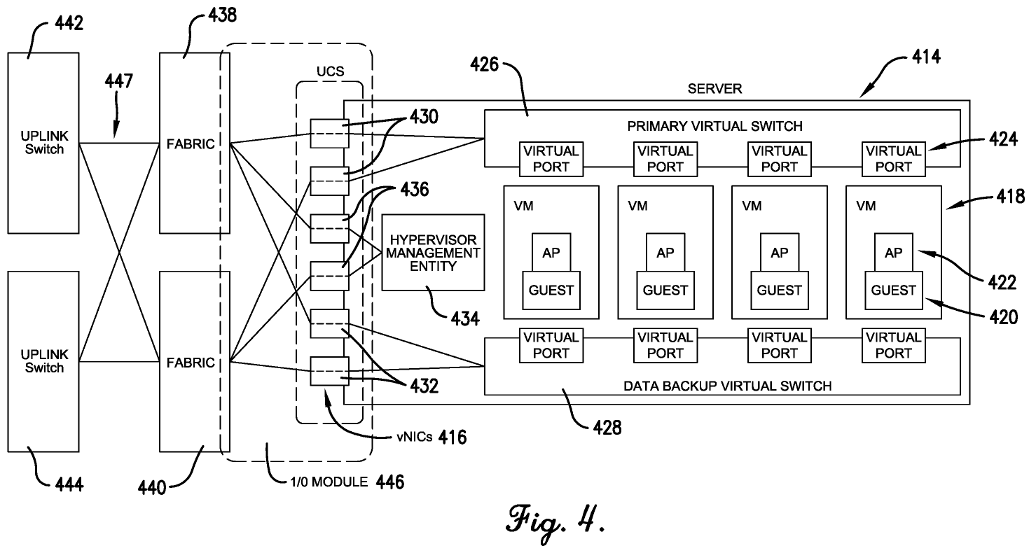

Referring to FIG. 4, the blade or other server 14 (of FIG. 1) may be virtualized to provide a virtualized server 414 having a plurality of vNICs 416 and a connection scheme for redundant switching. In more detail, the virtualized server 414 may include multiple VMs 418, with each VM 418 running its own operating system 420 and application 422 and connecting via virtual ports 424 to two or more virtual switches 426,428. Each of the virtual switches 426,428 may, in turn, be connected to a respective set 430,432 of two or more of the vNICs 416. The system may further include a hypervisor management entity 434 which is also connected to a set 436 of two or more of the vNICs 416.

The system may further include first and second physical fabrics 438,440, and first and second uplink switches 442,444. One of the vNICs 416 in each set 430,432,436 may be connected via an input/output (I/O) module 446 to the first fabric 438, and another of the vNICs in each set 430,432,436 may be connected via the I/O module 446 to the second fabric 440. Each fabric 438,440 may, in turn, be connected to both of the first and second uplink switches 442,444 by physical connections 447. Thus, each vNIC 416 of the first and second sets 430,432 may be associated with one of the first and second fabrics 438,440 and with one of the first and second virtual switches 426,428.

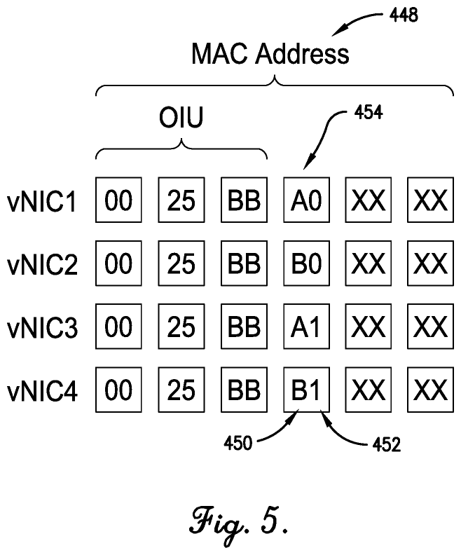

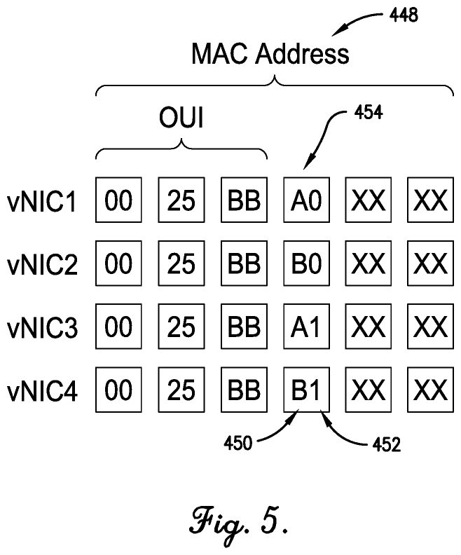

Referring also to FIG. 5, each vNIC 416 of the firsts and second sets 430,432 may be assigned an electronic MAC address 448 which includes a server connection value 450 which specifically identifies the particular connection with regard to the first and second fabrics 438,440, and a side connection value 452 which specifically identifies the particular side with regard to the first and second virtual switches 426,428. More specifically, implementations may use part of the six octet, twelve value (hexadecimal) MAC address for each vNIC 416 to identify the particular type of the server connection to the fabric interconnects 438,440 and the particular side connection to the virtual switches 426,428. This advantageously requires less logic and simplifies coding that uses or involves the MAC address. Providing a purpose-specific identifier in the MAC address itself eliminates the need for logic or call-ups to determine the line of communication or fabric interconnect for the vNIC because the coder (or script, if automated) needs only to look at the MAC address. In one implementation, the fourth octet 454 of the MAC address 448 may be used to insert the purpose-specific identifier. In other implementations, the fifth or sixth octets or a combination of octets may be used.

As shown in FIG. 5, for example, the four vNICs 416 of the first and second sets 430,432 may be assigned the following MAC addresses 448: 00:25:BB:A0:XX:XX; 00:25:BB:B0:XX:XX; 00:25:BB:A1:XX:XX; 00:25:BB:B1:XX:XX. The first three octets, which in these examples are “00:25:BB,” may be a license identifier for the vendor of the blade, and may be permanently assigned. The fifth and sixth octets, which in these examples are the placeholders “XX:XX,” may be randomly generated and temporarily assigned. The fourth octet 454 may be the purpose specific identifiers. In this example, “A” may represent a first fabric interconnect; “B” may represent a second fabric interconnect; “0” may represent a first primary switch; and “1” may represent a backup switch.

It may be desirable that the overall MAC address 448 for each vNIC 416 is unique to the network in which the virtualized server 414 is operating. Because the number of different values for the purpose-specific identifier in the fourth octet 454 are limited, in very large networks the fourth, fifth, and sixth octets may be insufficient to provide a unique MAC address for every port. In such cases it may be desirable to supplement “A” and “B” with additional values. For example, in order to increase the number of unique identifiers, “C” may also be used to represent the first fabric interconnect, and “D” may also be used to represent the second fabric interconnect. More specifically, “A:XX:XX” and “C:XX:XX” may be used for vNICs on the first fabric interconnect, and “B:XX:XX,” and “D:XX:XX” may be used for vNICs on the second fabric interconnect.

Further, “0” and “1” may be supplemented with additional values. For example, “2” may be used to represent a third switch, and “3” may be used to represent a fourth switch. This would result in eight new pools from which to draw: A0, A1, A2, A3, B0, B1, B2, and B3. Additionally or alternatively, like the server connection values representing the fabric interconnects, each of the possible side connections representing the switches may be represented by one of two or more values so to increase the number of unique identifiers.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A system comprising a physical server including a plurality of virtual network interface cards, wherein each virtual network interface card is associated with a particular connection of two or more possible connections and a particular side of two or more possible sides, and wherein the virtual network interface card is automatically and at least once very twenty-four hours assigned an electronic address which includes
a connection value which identifies the particular connection, and
a side value which identifies the particular side.

2. The system of claim 1, wherein the physical server is a blade server, and the electronic address is a media access control address.

3. The system of claim 1, wherein the two or more possible connections include a first physical fabric and a second physical fabric.

4. The system of claim 1, wherein the two or more possible sides include a first virtual switch and a second virtual switch.

5. The system of claim 1, wherein each possible connection of the two or more possible connections is identified by one of two or more values.

6. The system of claim 5, wherein the electronic address is a unique address within a particular network, and wherein each possible connection of the two or more possible connections is identified by one or more additional values to achieve the unique address.

7. The system of claim 1, wherein each possible side of the two or more possible sides is identified by one of two or more values.

8. The system of claim 7, wherein the electronic address is a unique address, and wherein each possible side of the two or more possible sides is identified by one or more additional values to achieve the unique address.

9. A system comprising a physical blade server including a plurality of virtual network interface cards, wherein each virtual network interface card is associated with a particular server connection of two or more possible server connections and a particular side connection of two or more possible side connections, and wherein the virtual network interface card is automatically and at least once every twenty-four hours assigned a media access control address which includes
a server connection value which identifies the particular server connection, and
a side connection value which identifies the particular side connection.

10. The system of claim 9, wherein the two or more possible server connections include a first physical fabric and a second physical fabric.

11. The system of claim 9, wherein the two or more possible side connections include first virtual switch and a second virtual switch.

12. The system of claim 9, wherein the media access control address is includes six octets, with each octet including two hexadecimal values.

13. The system of claim 12, wherein the server connection value and the side connection value are in a fourth octet of the media access control address.

14. The system of claim 9, wherein each possible server connection of the two or more possible server connections is identified by one of two or more hexadecimal values.

15. The system of claim 14, wherein the electronic address is a unique address within a particular network, and wherein each possible server connection of the two or more possible server connections is identified by one or more additional hexadecimal values to achieve the unique address.

16. The system of claim 9, wherein each possible side connection of the two or more possible side connections is identified by one of two or more hexadecimal values.

17. The system of claim 16, wherein the electronic address is a unique address within a particular network, and wherein each possible side connection of the two or more possible side connections is identified by one or more additional hexadecimal values to achieve the unique address.

18. A system comprising a physical blade server including
a plurality of virtual machines, with each virtual machine running an operating system and a software application and being connected via a first virtual port to a first virtual switch and being connected via a second virtual port to a second virtual switch;
two or more first virtual network interface cards connected to the first virtual switch, and one of the first virtual network interface cards being connected to a first physical fabric and another of the first virtual network interface cards being connected to a second physical fabric; and
two or more second virtual network interface cards connected to the second virtual switch, and one of the second virtual network interface cards being connected to the first physical fabric and another of the second virtual network interface cards being connected to the second physical fabric, wherein each the first and second virtual network interface cards is automatically and at least once every twenty-four hours assigned a media access control address having six octets, including a fourth octet which includes
a connection hexadecimal value which identifies the particular first or second physical fabric to which the virtual network interface card is connected, and
a side hexadecimal value which identifies the particular first or second virtual switch to which the virtual network interface card is connected.

19. The system of claim 18, wherein the virtual network interface cards are connected to the first and second physical fabrics by an input/output module.

20. The system of claim 18, wherein each of the first and second physical fabrics is connected to two or more uplink switches.
